(19) United States
(12) Patent Application Publication
(10) Pub. No.: US 2014/0362115 A1
(43) Pub. Date: Dec. 11, 2014

(54) IMAGE EDITING METHOD, IMAGE EDITING PROGRAM AND IMAGE EDITING DEVICE

(71) Applicant: FUNAI ELECTRIC CO., LTD., Osaka (JP)

(72) Inventors: Makoto HATA, Osaka (JP); Yusuke TAKENAKA, Osaka (JP)

(73) Assignee: FUNAI ELECTRIC CO., LTD., Osaka (JP)

(21) Appl. No.: 14/277,186

(22) Filed: May 14, 2014

(30) Foreign Application Priority Data
Jun. 6, 2013 (JP) 2013-119546

(51) Int. Cl. G06T 11/60

(52) U.S. Cl. CPC G06T 11/60
USPC 345/634

(57) ABSTRACT

An image editing method includes: a setting region detection step (S14) of detecting a region (Ar1) that is set by an operator within an image display region (10); a graphic element identification step (S15) of identifying a graphic element within the region (Ar1) that is set; a graphic information extraction step (S16) of extracting information included in the graphic element identified; and a graphic aggregation determination step (S17) of grouping, into a graphic aggregation, a relevant graphic element based on the graphic information.

This application is based on Japanese Patent Application No. 2013-119546 filed on Jun. 6, 2013, the contents of which are hereby “incorporated by reference.”

### BACKGROUND OF THE INVENTION

1. Field of the Invention

The present invention relates to a drawing editing device that edits an image including a plurality of graphic elements on an image display device.

2. Description of Related Art

An information processing device such as a personal computer, a portable information terminal or a tablet-type PC often includes an image editing program that uses an input device such a mouse or a touch panel to edit an image having a plurality of graphic elements. In the image editing program, the graphic elements are selected, and movement, change in shape and the like are performed to edit the image.

When the image editing described above is performed, a user operates the input device while visually recognizing an image displayed on an image display portion which is included in the information processing device or to which the information processing device is connected. If the image displayed on the image display portion is an image that includes a plurality of graphic elements, the graphic elements are often displayed so as to overlap each other. When a plurality of graphic elements overlap each other as described above, it is difficult for the user to select a desired graphic element from the graphic elements, and thus it is time-consuming to perform the editing. Hence, a method of assisting a user in selecting a desired graphic element from a plurality of graphic elements is proposed (for example, patent documents 1 and 2).

A handwriting data editing device of patent document 1 divides handwriting data input by handwriting into a character stroke and a graphic stroke, divides each of them into a character group and a graphic group and stores the data. Then, when an instruction to edit the character group or the graphic group is provided, updating is performed such that the details of the editing are reflected on the character group or the graphic group. As described above, the determination is made using the handwriting data, and thus it is possible to divide the graphic from the character, with the result that it is possible to reduce effort and time necessary for the editing

In a CAD system of patent document 2 (which corresponds to an image editing device of the present invention), when a pointer is put on an image displayed on a display portion, graphic elements arranged near the pointer are listed, and selection is made among the listed graphic elements. As described above, graphic elements are listed and selection is made among the list, and thus it is possible for a user to easily and reliably perform the selection on the graphic elements.

However, in the configuration of patent document 1 described above, since the handwriting data is divided into the character group and the graphic group, it is difficult to divide the character group and/or the graphic group into a plurality of different groups or to edit the character and the graphic separately. It is impossible to divide a group including both the character and the graphic.

In the configuration of patent document 2 described above, although the graphic elements near the pointer can be accurately selected, if the graphic elements are closely arranged or overlapped, it is difficult to accurately select a desired graphic element for a short period of time. When a plurality of graphics arranged in a wide area are grouped, the movement of the pointer and selection need to be repeatedly performed; in terms of this point, it also takes much effort and time.

### SUMMARY OF THE INVENTION

The present invention is made to solve the problem described above; an object of the present invention is to provide an image editing method, an image editing program and an image editing device in which with a simple operation, it is possible to easily and reliably select graphic elements.

According to one aspect of the present invention, there is provided an image editing method of editing an image displayed in an image display region, the image editing method including: a setting region detection step of detecting a region that is set by an operator within the image display region; a graphic element identification step of identifying a graphic element within the region that is set; a graphic information extraction step of extracting information included in the graphic element identified in the graphic element identification step; and a graphic aggregation determination step of grouping, into a graphic aggregation, a relevant graphic element based on the information extracted in the graphic information extraction step.

In the image editing method of the one aspect of the present invention described above, the user only sets the region within the image display region such that the graphic element desired to be selected is included, and thus it is possible to automatically select the graphic element desired to be selected. Thus, it is possible to select the graphic element by performing a simpler operation (intuitive operation) than a case where the graphic element is individually selected from the image.

In this way, the user simply and accurately can select the graphic element and/or the graphic aggregation desired.

In the image editing method of the one aspect of the present invention described above, in the graphic aggregation determination step, the graphic aggregation is determined based on information that is selected, based on an instruction from the operator, from the information extracted in the graphic information extraction step. In this configuration, it is possible to enhance the accuracy of the selection of the graphic element and/or the graphic aggregation desired by the operator.

The image editing method of the one aspect of the present invention described above, further includes: a graphic aggregation display step of displaying, in the image display region, the graphic aggregation determined in the graphic aggregation determination step. In this configuration, it is possible for the user to determine the graphic aggregation to be selected while viewing the separately displayed graphic aggregation together with the image, and it is possible to intuitively and accurately select the graphic element and/or the graphic aggregation desired.

In the image editing method of the one aspect of the present invention described above, in the graphic information extraction step, information on a time at which the graphic element is drawn is extracted, and in the graphic aggregation determination step, the graphic aggregation is determined based on an order of times at which the graphic elements are drawn. In this configuration, it is possible to determine the graphic aggregation into which the relevant graphic elements are grouped because the relevant graphics are often drawn chronologically and continuously. Thus, the user simply and accurately selects the aggregation of the associated graphic elements.

In the image editing method of the one aspect of the present invention described above, in the graphic aggregation determination step, the graphic elements are aligned in the order of times at which the graphic elements are drawn, and graphics that are drawn within a predetermined time period are grouped into one graphic aggregation. In this configuration, it is possible to accurately determine that the relevant graphic elements are the same graphic aggregation.

In the image editing method of the one aspect of the present invention described above, the time period can be changed based on an instruction from the operator, and in the graphic aggregation determination step, the changed time period is set at the predetermined time period, and the graphic aggregation is determined. In this configuration, it is possible to determine, according to a requirement from the user, that the graphic elements are the graphic aggregation.

In the image editing method of the one aspect of the present invention described above, in the graphic aggregation determination step, the graphic aggregation is determined based on an order in which the graphic elements are superimposed. In this configuration, even when a time elapses between the rounds of the drawing of the graphic elements, it is possible to determine that the relevant graphic elements are the same graphic aggregation.

In the image editing method of the one aspect of the present invention described above, in the graphic aggregation determination step, the graphic aggregation is determined based on the shape of the graphic elements. In this configuration, it is possible to perform editing for each of the shapes of the graphic elements.

In the image editing method of the one aspect of the present invention described above, in the graphic aggregation determination step, the graphic aggregation is determined based on the color of the graphic elements. In this configuration, it is possible to edit the colors of the graphic elements at one time.

An image editing program according to one aspect of the present invention instructs a computer to perform the above steps based on an instruction from the operator.

An image editing device according to one aspect of the present invention includes an image display means for displaying an image in an image display region, an input means for receiving an operation input from the operator and a processing means for performing the above steps.

In the present invention, it is possible to provide an image editing method, an image editing program and an image editing device in which with a simple operation, it is possible to easily and reliably select graphic elements.

### BRIEF DESCRIPTION OF THE DRAWINGS

FIG. 1 A schematic view of an image editing device according to the present invention;

FIG. 2 A block diagram showing the image editing device shown in FIG. 1;

FIG. 3 A diagram showing the details of an image shown in FIG. 1;

FIG. 4 A database of graphic information;

FIG. 5 A diagram showing a database of graphic groups;

FIG. 6 A flowchart of an image editing method according to the present invention;

FIG. 7 A schematic view showing an order in which graphic elements within a setting region are drawn;

FIG. 8 A diagram showing an example where graphic groups are displayed in an image display region;

FIG. 9 A flowchart showing another example of the image editing method according to the present invention;

FIG. 10 A diagram showing a state of display of the image display region when a standard time is shortened from a state of display shown in FIG. 8;

FIG. 11 A diagram showing a state of display of the image display region when the standard time is lengthened from the state of display shown in FIG. 8;

FIG. 12 A block diagram showing another example of the image editing device according to the present invention;

FIG. 13 A schematic view displaying graphic elements in order of drawing;

FIG. 14 A flowchart showing yet another example of the image editing method according to the present invention;

FIG. 15 A diagram showing graphic grouping in the image editing method according to the present invention;

FIG. 16 A diagram showing graphic grouping in the image editing method according to the present invention; and

FIG. 17 A diagram showing graphic grouping in the image editing method according to the present invention.

### DETAILED DESCRIPTION OF PREFERRED EMBODIMENTS

Embodiments of the present invention will be described below with reference to accompanying drawings.

### First Embodiment

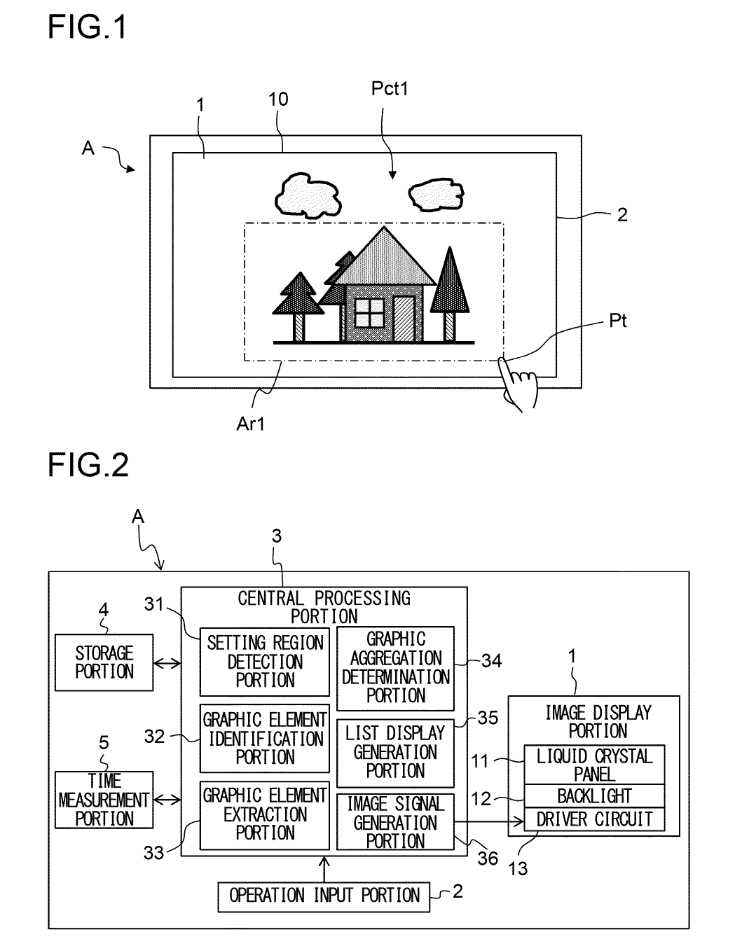

FIG. 1 is a schematic view of an image editing device according to the present invention, and FIG. 2 is a block diagram showing the image editing device shown in FIG. 1. As shown in FIGS. 1 and 2, the image editing device A is a tablet-type information terminal that is an example of an information processing device. The image editing device preferably includes a display position and an operation input portion, and may be, for example, a personal computer or a smartphone.

As shown in FIGS. 1 and 2, the image editing device A includes an image display portion 1 (image display means) and an operation input portion 2. The image display portion 1 includes a liquid crystal panel 11, a backlight 12 and a driver circuit 13. When light from the backlight 12 passes through a pixel (sub-cell), the liquid crystal panel 11 converts it into any of the types of light of RGB, and further changes its transmittance to display an image. The driver circuit 13 is a drive circuit that drives the liquid crystal panel 11 and the backlight 12, based on an image signal from an image signal generation portion 36, which will be described later. Although as the image display portion 1, the liquid crystal panel is used here, the present invention is not limited to this configuration, and display panels such as an organic EL can be widely adopted. In the image display portion 1, an image is displayed on an image display region 10 (region indicated by a rectangle in FIG. 1). Although in the present embodiment, the image editing device A incorporates the image display portion 1, the present invention is not limited to this configuration.

The operation input portion 2 is a touch panel device in which an input is performed by touching with a contact member called a pointer Pt (which is here assumed to be a finger of a user but the present invention is not limited to this configuration, and a pen-shaped member, a needle-shaped member or the like may be used). Instead of the touch panel, as the operation input portion, input devices, such as a mouse, that can detect coordinate data on the image display portion 1 can be widely adopted. The operation input portion 2 is a touch panel device that is equal or substantially equal in size to the image display region 10.

In an image Pct1 displayed on the image display portion 1, a cursor (not shown) indicating a point within the image display region 10 is displayed. The image Pct1 has a configuration in which a plurality of graphic elements are included. In the image editing device A, the user utilizes the operation input portion 2, and thereby can set an arbitrary part of the image display region 10 at a setting region Ar1.

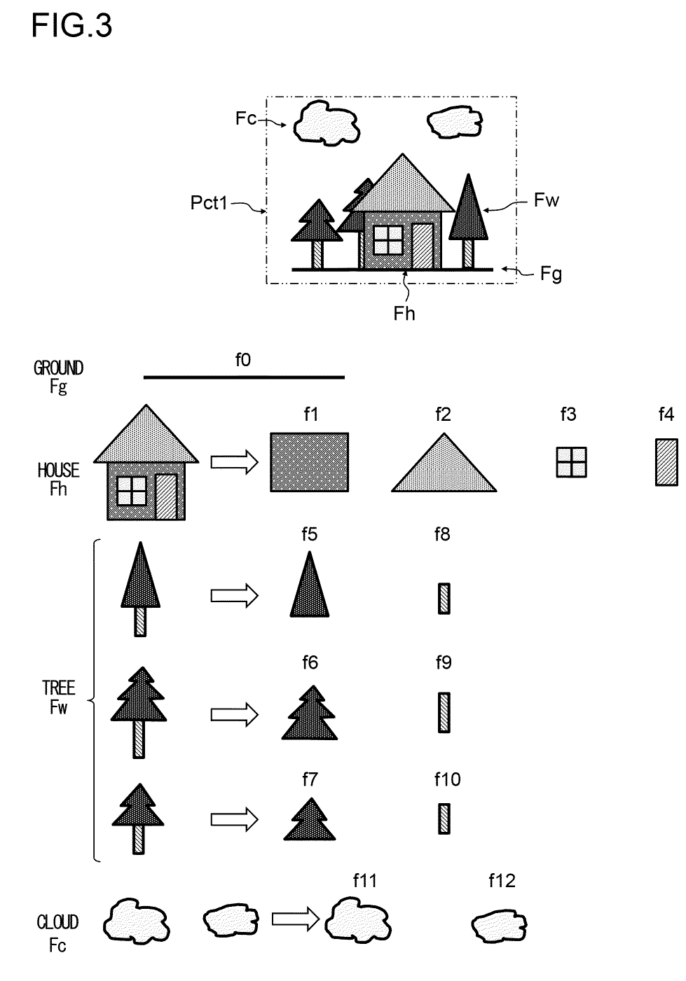

Here, the image Pct1 shown in FIG. 1 will be described with reference to drawings. FIG. 3 is a diagram showing the details of the image shown in FIG. 1. As shown in FIG. 3, the image Pct1 includes the images of a ground Fg, a house Fh, a tree Fw and a cloud Fc. The house Fh includes a body f1 (quadrangle), a roof f2 (triangle), a window f3 (quadrangle) and a door f4 (quadrangle). When the house Fh is assumed to be a collection (aggregation), the house Fh can also be considered to be an aggregation (graphic aggregation or graphic group) of graphics including a plurality of graphic elements.

The tree Fw includes leaves f5 to f7 (handwritten graphics) and trunks f8 to f10 (quadrangles). Furthermore, the cloud Fc includes two graphic elements, a left-side cloud f11 (handwritten graphic) and a right-side cloud f12 (handwritten graphic). The ground Fg is formed with only a straight line f0.

As shown in FIG. 3, the image Pct1 is an image that is formed with 13 graphic elements f0 to f12. In the above description, the house Fh, the tree Fw and the cloud Fc are assumed to be graphic groups. The graphic group is used for ease of the description (having a given connection). As described above, the graphic group may be formed by the meaning of the graphics (connection) or may be formed by another condition.

In order to perform the image editing as described above, the image editing device A further includes a central processing portion 3, a storage portion 4 and a time measurement portion 5 (see FIG. 2). The storage portion 4 is used for storing data containing image data for editing by the image editing device A. The storage portion 4 includes semiconductor memories such as a ROM that can perform only reading, a RAM that can perform both reading and writing and a flash memory. Instead of the semiconductor memories, a memory that performs recording in a recording medium such as a hard disk or an optical disc may be used. The storage portion 4 is connected to the central processing portion 3; the central processing portion 3, as necessary, can acquire information from the storage portion 4, and can store information in the storage portion 4.

The storage portion 4 stores not only image data on the image Pct1 but also information extracted from the graphic elements included in the image Pct1 (hereinafter may be referred to as graphic information). The graphic information will be described later.

The time measurement portion 5 is used for acquiring the current time and transmitting its time information to the central processing portion 3. The time measurement portion 5 functions not only as a timer for the current time but also as a timer for measuring an elapsed time based on an instruction from the central processing portion 3.

The central processing portion 3 is a processing device for performing image editing. The central processing portion 3 includes a computation processing device such as a CPU, and is an integrated circuit for performing computation. As shown in FIG. 2, the central processing portion 3 includes a setting region detection portion 31, a graphic element identification portion 32, a graphic information extraction portion 33, a graphic aggregation determination portion 34, a list display generation portion 35 and an image signal generation portion 36.

The setting region detection portion 31 is used for detecting coordinate information within the image display region 10 of the setting region Ar1 that is set by the user utilizing the operation input portion 2. In the image editing device A of the present invention, as the information for identifying the setting region Ar1, coordinate information on a corner portion in the image display region 10 is detected. Instead of the coordinate information on the corner portion, information capable of identifying the setting region Ar1 can be widely adopted.

The graphic element identification portion 32 identifies graphic elements included within the setting region detected by the setting region detection portion 31. For example, in the case of the image Pct1 shown in FIG. 1, graphic information f0 on the ground Fg, graphic elements (f1 to f4) included in the house Fh and graphic elements (f5 to f10) included in the tree Fw are identified.

The graphic information extraction portion 33 extracts graphic information included in the graphic elements (graphic elements f0 to f10) that are identified by the graphic element identification portion 32 to be included in the setting region Ar1. Graphic information is information that each graphic element includes, and the graphic information extracted by the graphic information extraction portion 33 is associated with the graphic element and is stored in the storage portion 4. Examples of the graphic information can include a shape, a color and a time but the present invention is not limited to these items.

The graphic aggregation determination portion 34 divides, based on the graphic information, into graphic groups, a plurality of graphic elements that are identified to be included in the setting region Ar1. Depending on the image, for predetermined graphic elements, graphic groups may be determined; in that case, the graphic aggregation determination portion 34 acquires information on the graphic groups from the storage portion 4 and determines the graphic groups. A specific method of determining graphic groups will be described later.

The image editing device A displays, as a list, on the image display portion 1, the graphic groups determined by the graphic aggregation determination portion 34. Hence, the list display generation portion 35 acquires information on the graphic groups determined by the graphic aggregation determination portion 34, and produces a display of the graphic groups (the graphic elements included therein) as a list. The list display generation portion 35 feeds, to the image signal generation portion 36, information on the list display of the graphic groups formed.

The image signal generation portion 36 is used for generating an image signal for operating the image display portion 1 based on image data called from the storage portion 4 and image data directly drawn through the operation input portion 2. In the image editing device A, for an image displayed, the setting region Ar1 is determined, and graphic elements included therein are grouped according to a predetermined criterion and are displayed in the form of a list as graphic groups. The list display of the graphic groups is preferably confirmed by comparison with the currently displayed image, and it is performed by superimposing in the state where the current image is displayed. Hence, the image signal generation portion 36 also has the function of combing the image signal of the current display image and the image signal of the list display.

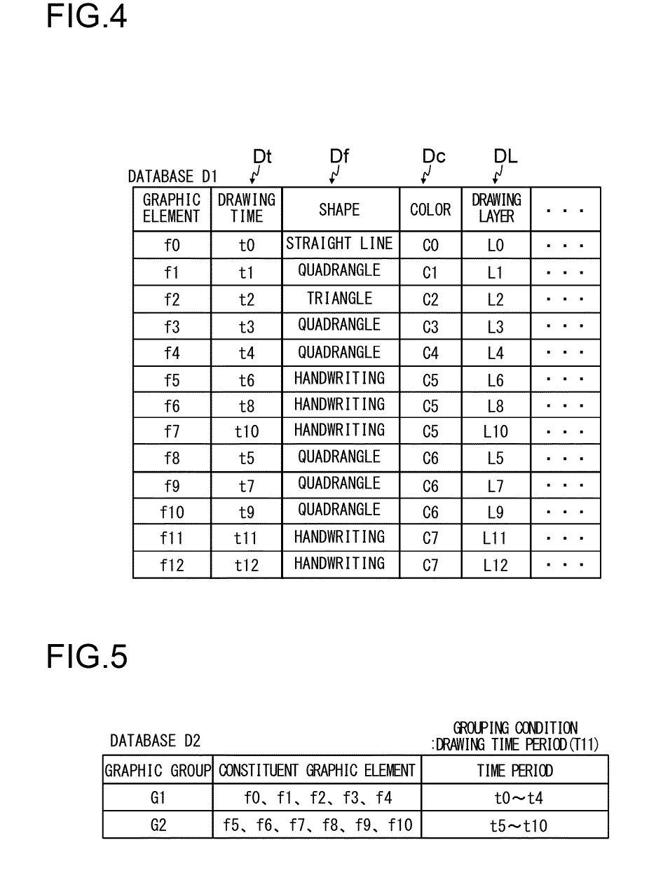

The graphic information will now be described with reference to drawings. FIG. 4 is a database of the graphic information. The database D1 shown in FIG. 4 is a database that is included in the image Pct1, and includes information on the individual graphic elements.

Specifically, the image Pct1 has the database D1 where a drawing time (drawing start time) Dt, a shape Df, a color Dc and a drawing layer DL for each graphic element are the graphic information. In the database D1 including the graphic information on the individual graphic elements included in the image Pct1, when the graphic element is drawn, the above graphic information is added. The image Pct1 may have a database different from the database D1, depending on an image drawing device or program. However, the graphic information on the graphic elements included in the image Pct1 is substantially the same, and it is assumed that the graphic information extraction portion 33 can extract the graphic information on the individual graphic elements.

The database D1 shown in FIG. 4 includes the drawing time Dt, the shape Df, the color Dc and the drawing layer DL for each drawing element. Here, the drawing layer DL is used for indicating a rank in which graphic elements are superimposed. For example, in the database D1, the drawing element f0 is set such that the drawing time Dt=t0, the shape Df=straight line, the color Dc=C0 and the layer DL=L0.

The storage portion 4 also has a database that retains information on graphic groups of an image whose graphic groups have been once determined FIG. 5 is a diagram showing a database on graphic groups. In the database D2 shown in FIG. 5, graphic groups, graphic elements included in the graphic groups and common graphic information on the graphic groups are shown. For example, in the database D2 shown in FIG. 5, graphic elements drawn within a predetermined time (T11) are set at the common graphic information. Specifically, graphic elements that have been drawn since the start of the drawing of the first graphic element until the predetermined time T11 are set at a graphic group G1, and after the predetermined time has elapsed since the start of the drawing, graphic elements that have been drawn since the start of the drawing of the subsequent graphic element until the predetermined time T11 are set at a graphic group G2.

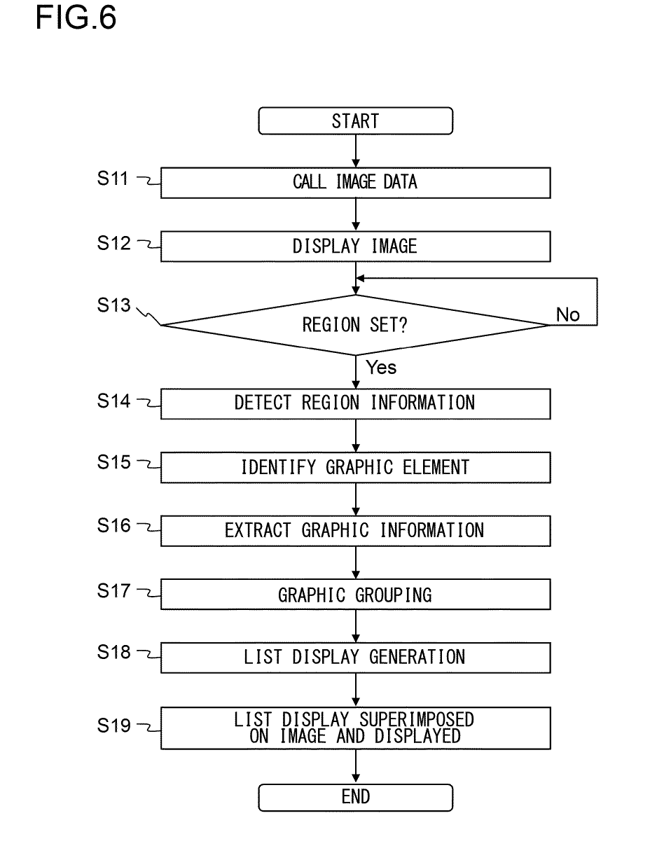

The operation of the image editing device A discussed above will be described with reference to drawings. FIG. 6 is a flowchart of an image editing method according to the present invention. The flowchart shown in FIG. 6 is used for editing the image Pct1 shown in FIG. 3 and shows a procedure for dividing the graphic elements included in the image Pct1 into a plurality of graphic groups. The image Pct1 shown in FIG. 3 is data that is previously drawn and stored in the storage portion 4.

The central processing portion 3 of the image editing device A calls, based on an instruction from the user, image data from the storage portion 4 (step S11). The central processing portion 3 feeds the image data called to the image signal generation portion 36, and displays it on the image display portion 1 (step S12).

The central processing portion 3 determines whether or not there is a setting region that is set by the user on the image display region 10 (step S13). If there is no setting region (in the case of no in step S13), the central processing portion 3 is placed on standby. If the setting region Ar1 (see FIG. 1 and the like) is set (in the case of yes in step S13), the setting region detection portion 31 detects the coordinate of the corner portion of the setting region Ar1 in the image display region 10 (step S14: a setting region detection step). Information on the setting region Ar1 determined by the setting region detection portion 31 is fed to the graphic element identification portion 32.

The graphic element identification portion 32 identifies, based on the information on the setting region Art, the graphic elements included in the setting region Ar1 (step S15: a graphic element identification step). As shown in FIG. 5, the graphic elements identified by the graphic element identification portion 32 are the graphic elements included in the setting region Ar1, the graphic elements f0 to f10.

The graphic element extraction portion 33 of the central processing portion 3 extracts, from the database D1 (see FIG. 4) included in the image Pct1 stored in the storage portion 4, the information on the graphic elements (f0 to f10) included in the setting region Ar1 (step S16: a graphic information extraction step). The graphic aggregation determination portion 34 determines, based on the graphic information extracted by the graphic element extraction portion 33, that graphic elements satisfying a predetermined condition are set at a graphic group (step S17: a graphic aggregation determination step).

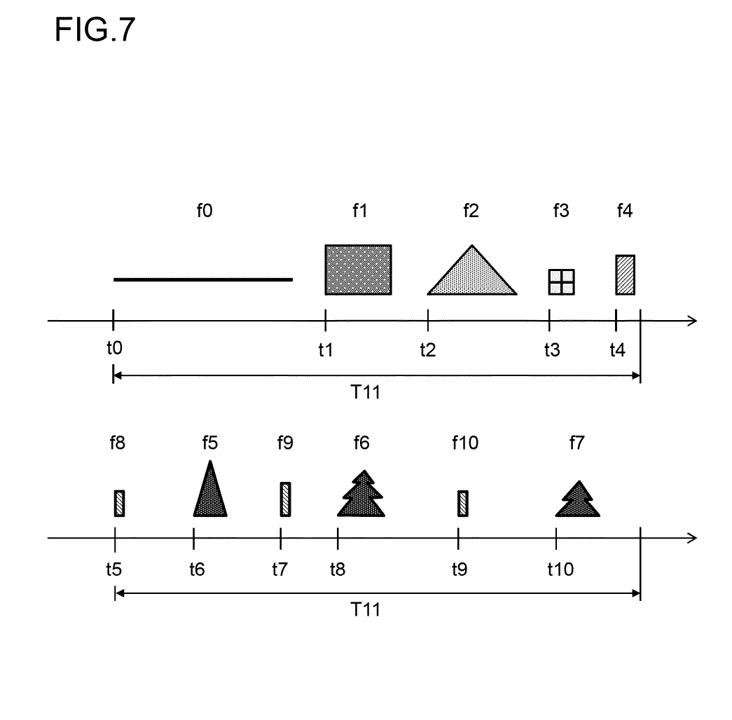

The graphic aggregation determination step will be described in detail with reference to drawings. FIG. 7 is a schematic diagram showing an order in which the graphic elements within the setting region are drawn. The order of the graphic elements shown in FIG. 7 is the order of drawing times in which the graphic elements (f0 to f10) within the setting region Ar1 of the image Pct1 are drawn, shown in FIG. 4.

FIG. 7 also displays times when the graphic elements within the setting region start to be drawn. For example, for the drawing element f0, the drawing is started at time t0.

The graphic aggregation determination portion 34 of the central processing portion 3 is used for setting the graphic elements whose drawing times fall within a predetermined time period (here, the standard time T11) at the same graphic group. As shown in FIG. 7, in the image Pct1, until the standard time T11 has elapsed, the graphic elements from f0 to f4 are drawn. Hence, the graphic aggregation determination portion 34 determines that the graphic elements f0, f1, f2, f3 and f4 are the graphic group G1.

Likewise, since the start of the drawing of the graphic element f8 drawn subsequent to the graphic element f4 until the standard time T11 has elapsed, the graphic elements f5, f9, f6, f10 and f7 are drawn. Hence, the graphic aggregation determination portion 34 determines that the graphic elements f5, f6, f7, f8, f9 and f10 are the graphic group G2.

In other words, in the procedure described above, the graphic aggregation determination portion 34 groups the graphic elements within the setting region Ar1 into the two graphic groups G1 and G2. In the image editing device A, the graphic elements included in the graphic groups G1 and G2 are displayed in the image display region 10 so as to be superimposed on the image Pct1. Hence, the list display generation portion 35 acquires, from the graphic aggregation determination portion 34, information on the graphic elements of the graphic groups to generate list display information (step S18: a graphic aggregation display step). Then, the image signal generation portion 36 generates an image signal of the graphic group which is displayed so as to be superimposed on the image Pct1 based on the list display information, combines it with an image signal of the image Pct1 and feeds it to the image display portion 1 (step S19: a graphic aggregation display step).

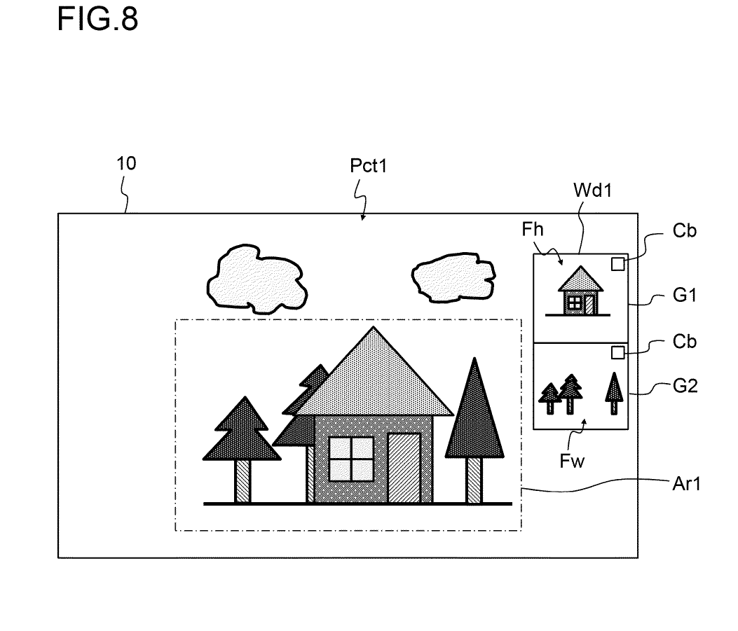

An example where the graphic groups are displayed in the image display region in the procedure described above will be shown in FIG. 8. FIG. 8 is a diagram of the image display region 10 of the image editing device A; in the right side of the image Pct1, a window Wd1 in which the determined graphic groups are displayed is displayed so as to be superimposed on the image display region 10. In the window Wd1, the graphic group G1 and the graphic group G2 are displayed, and in the upper right part of each of the graphic groups, a check box Cb is provided. The user checks the check box Cb and thereby can select the graphic group.

Then, when the graphic group is selected in the window Wd1, the graphic elements included in the selected graphic group are also selected in the image Pct1, and thus it is possible to edit the selected graphic elements at one time. For example, when the check box Cb in the upper right part of the graphic group G1 is checked, in the image Pct1, the image (graphic group) of the house Fh is selected, and thus it is possible to perform editing such as movement, enlargement and the like on the house Fh.

In this way, the user only sets the setting region such that the graphic desired to be selected is put thereinto, and thus it is possible to select the desired graphic, with the result that it is possible to simplify the operation of editing the image.

The image editing method described above can be widely adopted for things, such as a handwritten character and a number, that can be regarded as graphics. The same holds true for following image editing method.

### Second Embodiment

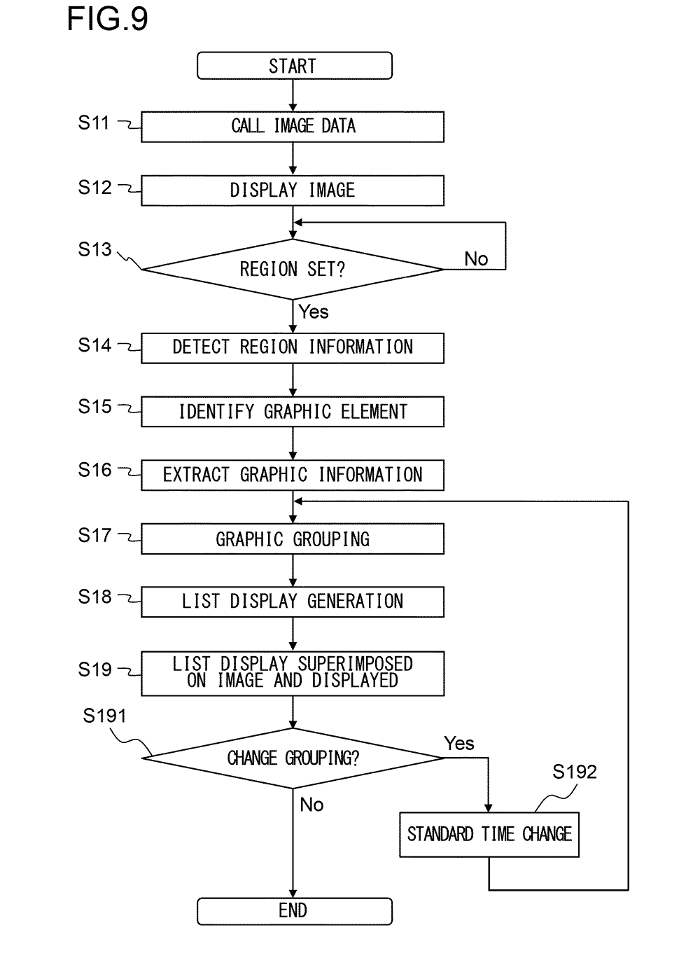

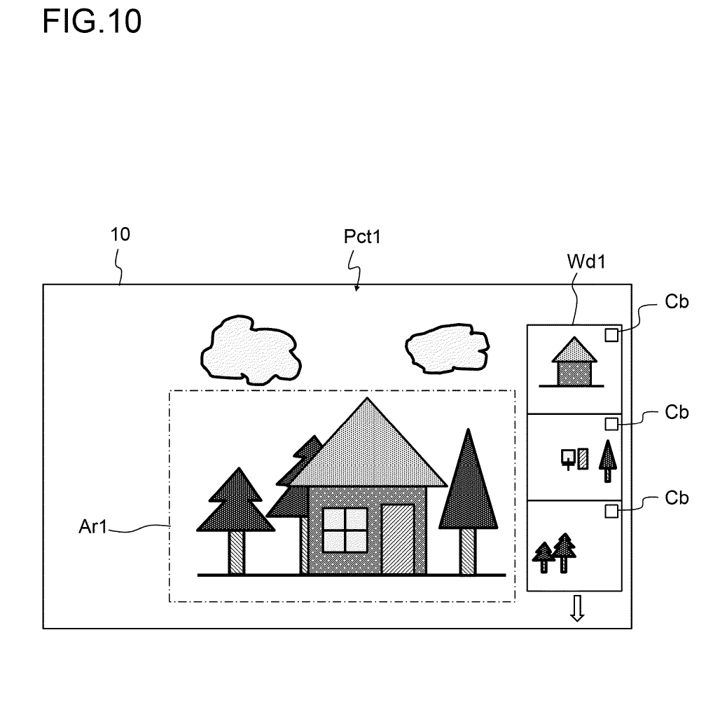

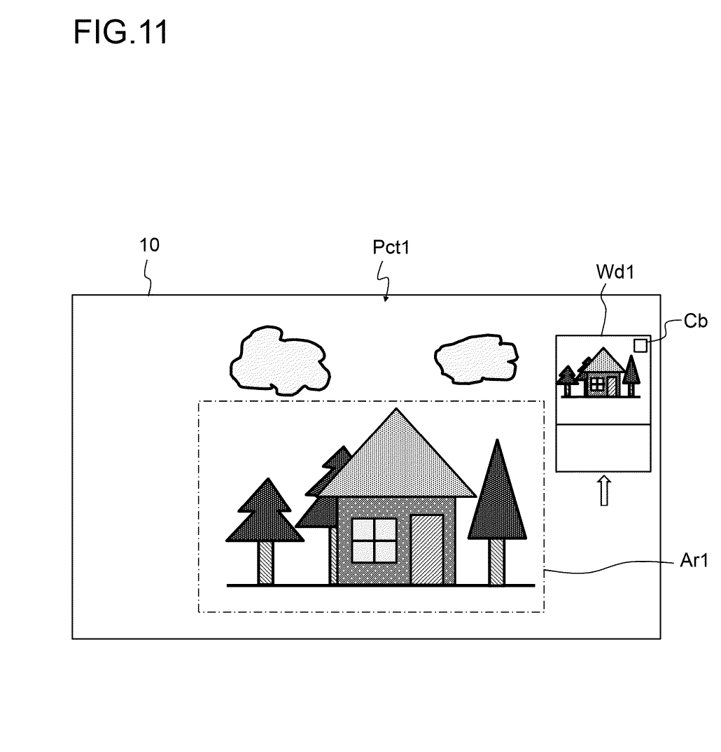

In the case of the method of, as described above, determining that the graphic elements drawn within the standard time are one graphic group, the number of graphic elements may be more or less than the number of desired graphic elements. Hence, in the image editing method of the present embodiment, the determination of the graphic group is repeatedly performed, and thus the graphic elements included in the graphic groups are set finely. FIG. 9 is a flowchart showing another example of the image editing method according to the present invention. An image editing device used in the image editing method of the present embodiment has the same configuration as that of the image editing device A shown in FIGS. 1 and 2. The image display of the image display region 10 when the graphic group is determined is shown in FIGS. 10 and 11,

The flowchart shown in FIG. 9 is the same as that shown in FIG. 6 except that steps S191 and S192 are provided after step S19. Hence, the description except steps S191 an S192 will be omitted.

After the completion of step S19, the image display region 10 is as shown in FIG. 7, and the image Pct1 and the window Wd1 are displayed so as to be superimposed. For the graphic groups G1 and G2 as shown in FIG. 7, it may be impossible to determine the graphic group including the desired graphic element. Hence, an input of an instruction of whether or not the graphic group is changed by the use is acquired (step S191). If an instruction that it is not necessary to change the graphic group is acquired (in the case of no in step S191), the grouping of the graphic elements is completed.

If an input of an instruction that it is necessary to change the graphic group is acquired (in the case of yes in step S191), the central processing portion 3 changes the standard time (step S192) and returns to step S17, where the graphic elements are grouped again. By changing the standard time, it is possible to change the number of graphic elements included in the graphic group.

Here, the method of changing the standard time will be described with reference to drawings. FIG. 10 is a diagram showing a state of the display of the image display region when the standard time is shortened from the state of the display shown in FIG. 8, and FIG. 11 is a diagram showing a state of the display of the image display region when the standard time is lengthened from the state shown in FIG. 8.

As the standard time is shortened, the number of graphic elements included in the graphic group is decreased whereas as the standard time is lengthened, the number of graphic elements is increased. In other words, as the standard time is shortened, the number of graphic groups is increased whereas as the standard time is lengthened, the number of graphic groups is decreased. In the image editing method of the present invention, the relationship between the length of the standard time and the number of graphic groups is utilized, and thus the standard time is adjusted.

The window Wd1 in FIG. 10 is lengthened as compared with that in FIG. 8 in the image display region 10. By lengthening the window Wd1, it is possible to increase the number of graphic groups that can be displayed. In other words, the window Wd1 is changed such that the window Wd1 is lengthened, and thus the standard time is shortened, with the result that the number of graphic groups displayed is increased. As shown in FIG. 11, the window Wd1 is shortened, and thus the standard time is lengthened, with the result that the number of graphic groups displayed is reduced.

As described above, the length of the window Wd1 is changed, and thus the length of the standard time is adjusted, and the graphic group where the grouping is practically performed based on the drawing time is changed, and thus the user can intuitively change the standard time and the graphic group by changing the standard time.

Although in the present embodiment, the length of the window Wd1 is directly changed, a graphic display (for example, a slider) for changing the standard time is produced, and the graphic display may be utilized. When the number of graphic groups is increased, it may be difficult to display all graphic groups in the image display region 10. In this case, the window Wd1 may be displayed such that the window Wd1 can be scrolled. Alternatively, the graphic displayed in the window may be reduced so as to be placed in the image display region 10.

In this configuration, the user can intuitively select the desired graphic element. The features other than this are the same as in the first embodiment.

### Third Embodiment

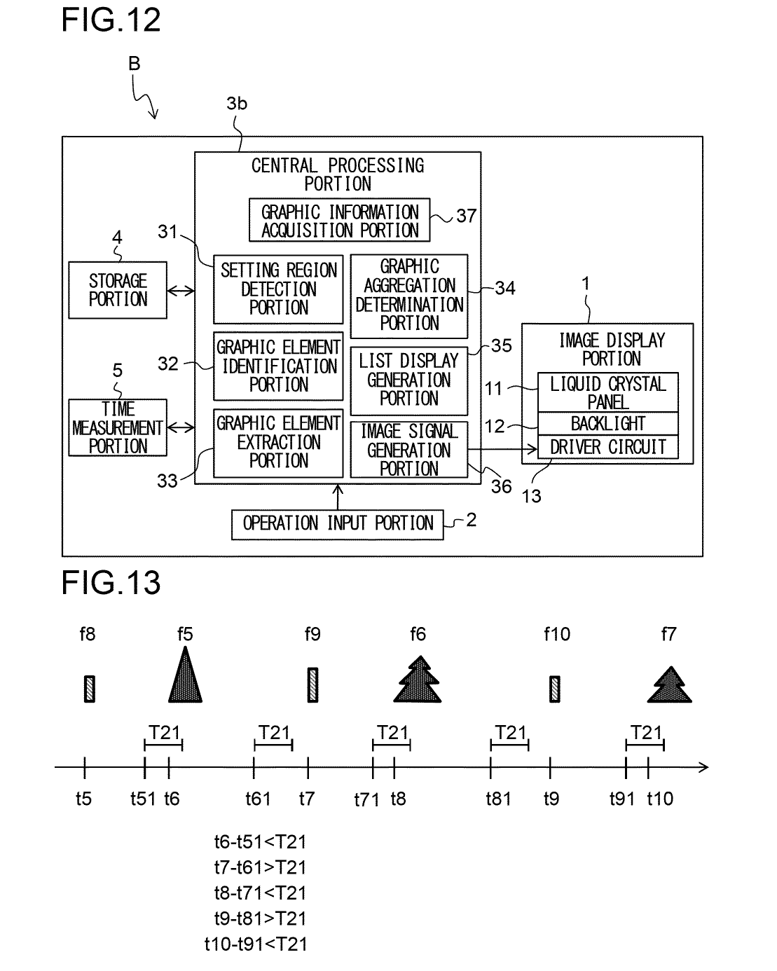

Yet another example of the image editing method according to the present invention will be described with reference to drawings. FIG. 12 is a block diagram showing another example of the image editing device according to the present invention. The image editing device B shown in FIG. 12 has the same configuration as that of the image editing device A shown in FIG. 2 except that a central processing portion 3b includes a graphic information acquisition portion 37; the substantially same parts are identified with the same symbols, and their detailed description will be omitted.

In the image editing device B shown in FIG. 12, the operation input portion 2 is utilized, and thus it is possible to draw an image (graphic elements). The image editing device B includes the graphic information acquisition portion 37 which acquires, when graphic elements are drawn, information on the drawn graphic elements.

The graphic information acquisition portion 37 acquires, as graphic information, a drawing start time and a drawing completion time of a graphic element, information on the shape of the graphic element, the color of the graphic element and a layer of the graphic information. Then, the graphic information acquisition portion 37 adds a newly drawn graphic element and graphic information on the graphic element to the database D1 of the image (see FIG. 4).

Since the image editing device B includes the graphic information acquisition portion 37, it is possible to acquire, as the graphic information on the graphic element, the graphic information necessary for editing the image. Thus, it is possible to make it easy for the user to select the desired graphic group. The features other than this are the same as in the first and second embodiments.

### Fourth Embodiment

Yet another example of the image editing method according to the present invention will be described with reference to drawings. FIG. 13 is a schematic view showing an order in which the graphic elements are drawn. FIG. 13 displays the order in which the graphic elements included in the tree Fw of the image Pct1 shown in FIG. 1 and the like are drawn. Although the image editing method of the present embodiment will be described with assumption that the image editing method is applied to the image editing device B, when an image having a graphic element drawing completion time as graphic information is edited, the image editing method can likewise be applied to the image editing device A.

As shown in FIG. 13, the graphic elements of the tree Fw are drawn in the following order: a graphic element f8 indicating a trunk, a graphic element f5 indicating a leaf, a graphic element f9 indicating a trunk, a graphic element f6 indicating a leaf, a graphic element f10 indicating a trunk and a graphic element f7 indicating a leaf.

As shown in FIG. 13, the drawing start time of the graphic element f8 is time t5, and the drawing completion time is time t51. The drawing start time of the graphic element f5 is time t6, and the drawing completion time is time t61. The drawing start time of the subsequent graphic element f9 is time t7.

For example, when the tree including the graphic elements f8 and f5 is desired to be selected as a graphic group, it is possible to perform the method of changing the standard time as described above. However, if the graphic element drawn as the last of the graphic groups is the graphic element f8, it is difficult to put the graphic elements f8 and f5 into the same group. Hence, in the graphic editing method of the present embodiment, the graphic group is determined for a time during which the graphic element is drawn.

In other words, in the image editing method of the present embodiment, when a time until the subsequent graphic element is drawn is short, the graphic elements before and after that time are determined as one graphic group. Depending on whether the time during which the graphic element is drawn is longer or shorter than the standard time T21, whether or not the graphic element is included in the graphic group is determined.

The method of determining the graphic group will be described in further detail. As shown in FIG. 13, the drawing of the graphic element f8 is completed at time t51, and the drawing of the graphic element f5 is started at time t6. In other words, a time (t6-t51) elapses between the completion of the drawing of the graphic element and the start of the drawing of the graphic element f5. Since in FIG. 13, the time (t6-t51) is shorter than the standard time T21, the graphic elements f8 and f5 are determined as one group.

On the other hand, the drawing of the graphic element f5 is completed at time t61, and the drawing of the graphic element f9 is started at time t7. A time (t7-t61) elapses between the completion of the drawing of the graphic element f5 and the start of the drawing of the graphic element f9. Since in FIG. 13, the time (t7-t61) is longer than the standard time T21, the graphic elements f5 and f9 are determined as different groups. In other words, the graphic elements f8 and f5 are determined as one group, and the graphic elements f9 and f5 are determined as different groups.

As described above, the graphic groups are determined, and thus it is possible to omit, as the time for determining the graphic groups, the time necessary for drawing the graphic groups themselves, and it is possible to correctly determine the graphic elements included in the graphic group. For example, it is possible to determine a graphic group including a plurality of graphic elements that need to take a long time to perform drawing. The features other than this are the same as in the first, second and third embodiments.

A handwritten character may be selected as a handwritten graphic. In a handwritten character, in general, a time between the completion of the drawing of a stroke (portion drawn by one stroke of a character) and the start of the drawing of the subsequent stroke within the same character is short, and in most cases, a necessary time between characters is long. Since a handwritten character has such a feature, the graphic editing method of the present embodiment is used, and thus it is possible to set the graphic of the handwritten character at one graphic group per character.

### Fifth Embodiment

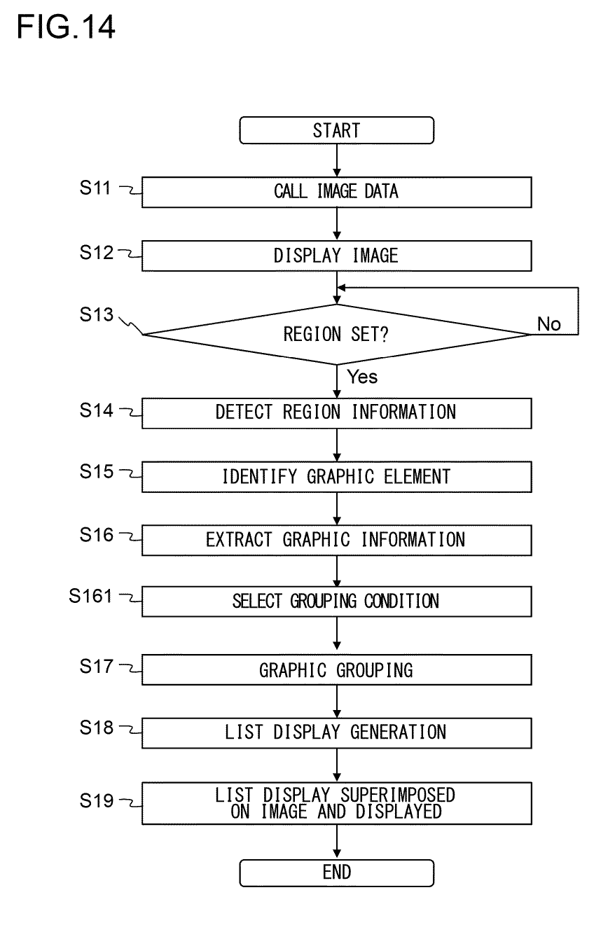

Yet another example of the image editing method according to the present invention will be described with reference to drawings. FIG. 14 is a flowchart of the example of the image editing method according to the present invention. The flowchart shown in FIG. 14 is the same as that shown in FIG. 6 except that step S161 is provided after step S16. Hence, the description other than step S161 will be omitted. Although the flowchart of the present embodiment will be described with assumption that the flowchart is applied to the image editing device A, the flowchart can likewise be applied to the image editing device B.

As shown in FIG. 4 and the like, each graphic element includes a plurality of pieces of graphic information (the drawing time, the shape, the color, the layer and the like). The graphic element extraction portion 33 acquires a plurality of pieces of graphic information for each graphic element, and can perform grouping based on these pieces of graphic information. Hence, in the image editing method of the present embodiment, after the extraction of the graphic information (step S16), a condition for graphic grouping is selected (step S161). Examples of the condition for graphic grouping include, as described above, the time from the start of the drawing, the time during which the graphic element is drawn, the shape of the graphic element, the color and the layer.

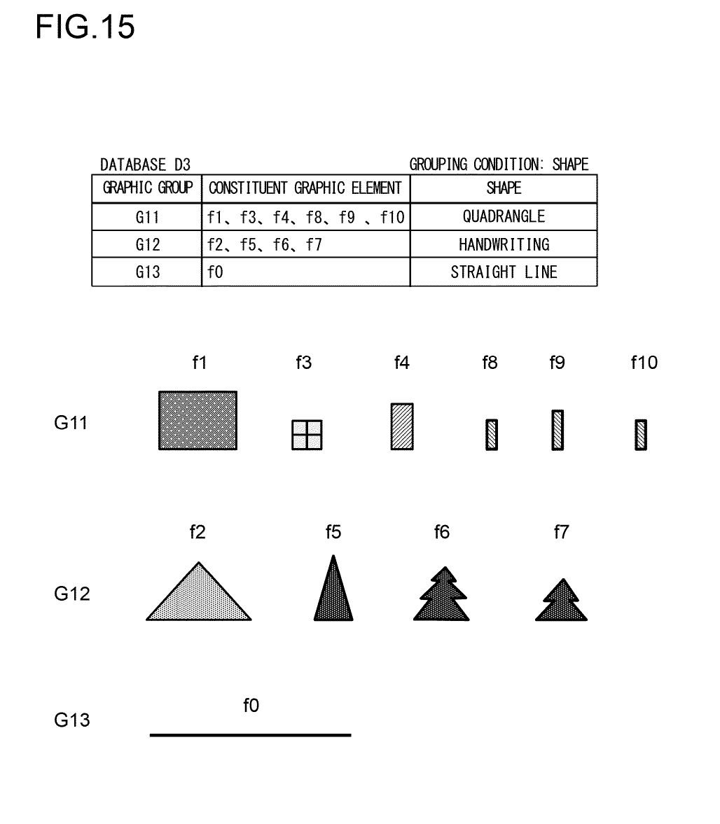

Another example of the image editing method according to the present invention will be described below with reference to drawings. FIGS. 15 to 17 are diagrams that show graphic grouping in the image editing method of the present invention. Although in FIGS. 15 to 17, the graphic elements are displayed as a list for ease of understanding, they are actually displayed in the window Wd1 within the image display region 10 shown in FIG. 8.

FIG. 15 is a diagram showing a database obtained by determining the graphic groups according to the type of graphic and the graphic elements. As shown in the database D3 of FIG. 15, a graphic group G11 includes quadrangular graphic elements f1, f3, f4, f8, f9 and f10. A graphic group G12 includes handwritten graphic elements f2, f5, f6 and f7. Furthermore, a graphic group G13 includes a linear graphic element f0.

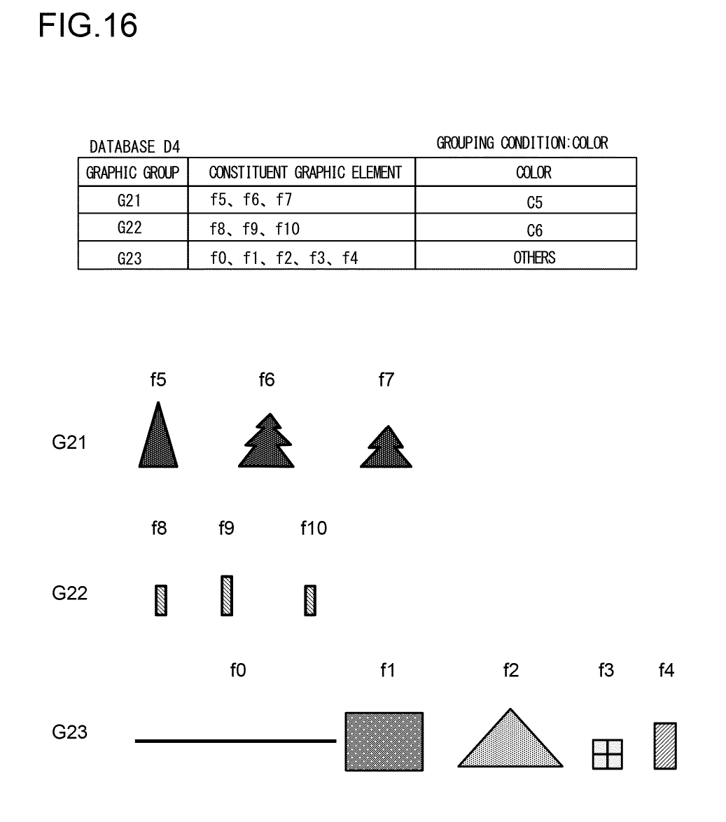

FIG. 16 is a diagram showing a database obtained by determining the graphic groups according to the color of the graphic element and the graphic elements. In FIG. 16, since the graphic having the same color information is only the tree Fw, the graphic elements f5 to f10 of the tree Fw are subjected to graphic grouping, and the remaining graphic elements are grouped as the other group. As shown in the database D4 of FIG. 16, a graphic group G21 includes the graphic elements f5 to f7 of a color C5 (see FIG. 4). A graphic group G22 includes the graphic elements f8 to f10 of a color C6 (see FIG. 4). Then, the other graphic elements are grouped as the other group G23.

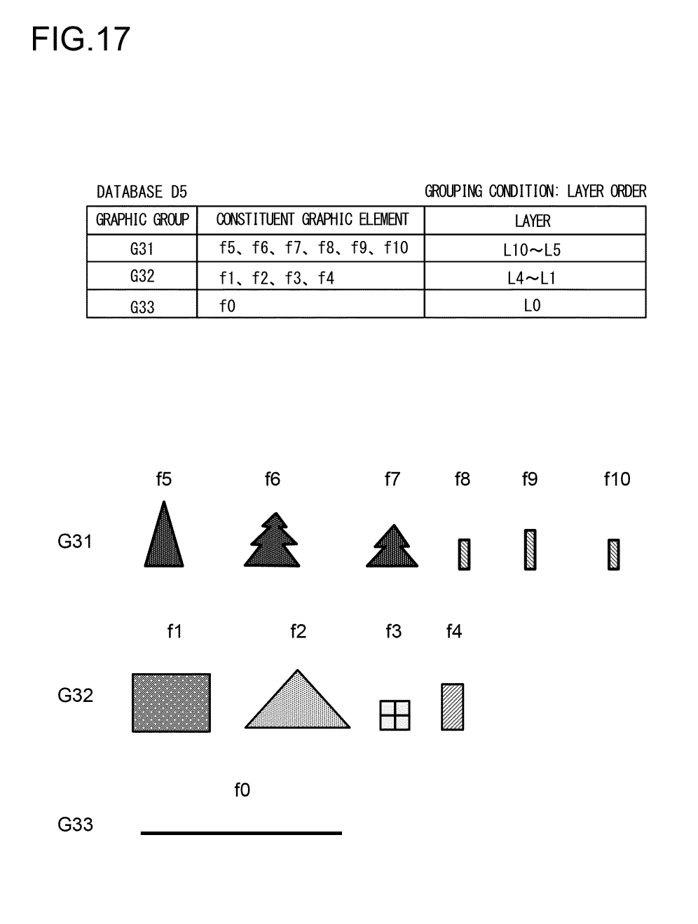

Furthermore, FIG. 17 is a diagram showing a database obtained by determining the graphic groups according to the layer of the graphic element and the graphic elements. As shown in the database D5 of FIG. 17, a graphic group G31 includes the graphic elements f8, f5, f9, f6, f10 and f7 that are drawn in the six layers from the top. A graphic group G32 includes the graphic elements f1 to f4 that are drawn in the layers from the seventh layer from the top to the tenth layer. Furthermore, a graphic group G33 includes the graphic element f0 drawn in the bottom layer.

Since the user can determine the condition for graphic grouping as described above, it is possible to accurately determine the graphic elements included in the graphic groups. The features other than this are the same as in the first to fourth embodiments.

Although the embodiments of the present invention have been described above, the present invention is not limited to the details thereof. In the embodiments of the present invention, various modifications are possible without departing from the spirit of the present invention.

What is claimed is:

1. An image editing method of editing an image displayed in an image display region, the image editing method comprising:
a setting region detection step of detecting a region that is set by an operator within the image display region;
a graphic element identification step of identifying a graphic element within the region that is set;
a graphic information extraction step of extracting graphic information included in the graphic element identified in the graphic element identification step; and
a graphic aggregation determination step of grouping, into a graphic aggregation, a relevant graphic element based on the graphic information extracted in the graphic information extraction step.

2. The image editing method of claim 1,
wherein in the graphic aggregation determination step, the graphic aggregation is determined based on information that is selected, based on an instruction from the operator, from the information extracted in the graphic information extraction step.

3. The image editing method of claim 1, further comprising:
a graphic aggregation display step of displaying, in the image display region, the graphic aggregation determined in the graphic aggregation determination step.

4. The image editing method of claim 1,
wherein in the graphic information extraction step, information on a time at which the graphic element is drawn is extracted, and
in the graphic aggregation determination step, the graphic aggregation is determined based on an order of times at which the graphic elements are drawn.

5. The image editing method of claim 4,
wherein in the graphic aggregation determination step, the graphic elements are aligned in the order of times at which the graphic elements are drawn, and graphics that are drawn within a predetermined time period are grouped into one graphic aggregation.

6. The image editing method of claim 5,
wherein the time period can be changed based on an instruction from the operator, and
in the graphic aggregation determination step, the changed time period is set at the predetermined time period, and the graphic aggregation is determined.

7. The image editing method of claim 1,
wherein in the graphic aggregation determination step, the graphic aggregation is determined based on an order in which the graphic elements are superimposed.

8. The image editing method of claim 1,
wherein in the graphic aggregation determination step, the graphic aggregation is determined based on a shape of the graphic elements.

9. The image editing method of claim 1,
wherein in the graphic aggregation determination step, the graphic aggregation is determined based on a color of the graphic elements.

10. A storage medium in which an image editing program that is performed by a computer is recorded, the storage medium comprising:
a setting region detection step of detecting a region that is set by an operator within an image display region;
a graphic element identification step of identifying a graphic element within the region that is set;
a graphic information extraction step of extracting graphic information included in the graphic element identified in the graphic element identification step; and
a graphic aggregation determination step of grouping, into a graphic aggregation, a relevant graphic element based on the graphic information extracted in the graphic information extraction step.

11. An image editing device comprising:
an image display portion that displays an image in an image display region;
an operation input portion that receives an operation input by an operator;
a setting region detection portion that detects a region that is set by the operator within the image display region;
a graphic element identification portion that identifies a graphic element within the region that is set;
a graphic information extraction portion that extracts graphic information included in the graphic element identified in the graphic element identification portion; and
a graphic aggregation determination portion that groups, into a graphic aggregation, a relevant graphic element based on the graphic information extracted in the graphic information extraction portion.
